(19) United States
(12) Patent Application Publication
(10) Pub. No.: US 2026/0170240 A1
(43) Pub. Date: Jun. 18, 2026

(54) STATISTICAL LANGUAGE-BASED MODEL SYSTEM FOR RECONSTRUCTING AUTHOR IDENTITY FROM FRAGMENTED INFORMATION

(71) Applicants: Justin S Altshuler, North Miami, OH (US); Larry Turner, Dayton, OH (US)

(72) Inventors: Justin S Altshuler, North Miami, OH (US); Larry Turner, Dayton, OH (US)

(21) Appl. No.: 18/980,510

(22) Filed: Dec. 13, 2024

(51) Int. Cl. G06F 40/20

(52) U.S. Cl. CPC G06F 40/20

(57) ABSTRACT

A system, computer program product, and method of author identification whereby text published by an author is received from a source, affirmed for characteristics of personalization, associated with fragments of identity from a plurality of sources, and matched to known identities. Artificially intelligent language model agents are instructed how to examine the original text source to find and examine fragments of information that point to a partial or complete identity of the author and match those fragments to known identities.

### BACKGROUND OF THE INVENTION NT & ARK

For decades, there has been a need to identify authors of text posted online. Government and first responder agencies, legal professionals, health personnel, advertisers, and businesses providing products and services all benefit from the ability to match publicly posted text to an individual. For example, a victim of a flood may publish text about their predicament on social media. This “post” may be relayed to first responders that an emergency response is needed. In another example, a business that sells dog treats may wish to send an advertisement to someone who posted “I love my dog!” in a comment section of a news story. In both examples, the full identity of the author may not be available or obvious, Previous techniques can require someone experienced in deduction to match the identity of the author manually.

From these deficiencies, there exists an ongoing need for improved methods of identifying individuals from text data where the identity is not available or obvious. In addition, there exists a need for such improved methods to be sufficiently fast so as to allow them to be used in many different applications. The present embodiments relate to a system for reconstructing author identity from fragmented data utilizing an automated artificially intelligent research agent such as, for example, an “LLM,” and a related computer program product and machine-executed method.

A LLM (Large Language Model) is useful to achieve general-purpose language understanding and generation.

A SLM (Small Language Model) is useful to verify specific structures.

### SUMMARY OF THE INVENTION

This summary highlights various key aspects, benefits, and innovative elements of the inventions presented. However, it should be noted that not all these benefits might be realized in every version of the invention. Therefore, the invention can be implemented or executed in a way that focuses on achieving or enhancing one particular benefit or a set of benefits as explained in this document, without necessarily attaining every other advantage that has been mentioned or implied.

Embodiments for the present invention disclose a method, a computer program product, and a computer system for identifying individuals from text data using a plurality of artificially intelligent natural language agents instructed to find, compare, and match fragments of an identity with known identities.

In one embodiment, public texts are recursively received and collected from a plurality of sources. In one entry, an individual has posted on social media that they are stranded in a flood. The text of the post is analyzed to determine if it includes characteristics of personalization, for example, I, me, my, mine, us, we, our, etc. One or more artificially intelligent natural language agents examine the entry source to find fragments of the identity; first name, last name, address, city, state, zip code, phone number, email, social media handle etc., as well as pointers to new sources that may also contain fragments of the identity, work, school, friends, followers, relative, associates, etc. Found fragments are then compared to entries of known identities, and the identity of the author is returned. The identity of the author combined with the contents of the original post may be useful to government officials and first responders, as well as family members, legal professionals and providers of goods and services.

In other embodiments, a use of the word flood or flooded may not indicate immediate danger, and after examination, only return partial fragments of identity. This partial identity is also useful in context of the post.

### TECHNICAL FIELD

The present invention relates to a method and system for identifying individuals from text data using a plurality of artificially intelligent natural language agents.

### BRIEF DESCRIPTION OF DRAWINGS

FIG. 1 is a functional block diagram of a computer system comprising an author identification system as per one aspect of the exemplary embodiment;

FIG. 2A is a flowchart illustrating a method for identifying an author as per one facet of the exemplary embodiment; and

FIG. 2B is a flowchart illustrating a method for identifying an author as per another facet of the exemplary embodiment;

FIG. 3 shows one representative screenshot that appears on the display of the computer system from FIG. 1 during a request to refine the topic of an author's text;

FIG. 4 shows one representative screenshot that appears on the display of the computer system from FIG. 1 during an identification of an author;

FIG. 5 shows an alternative representative screenshot that appears on the display of the computer system from FIG. 1 during an identification of an author.

### DETAILED DESCRIPTION

It should be clear that the elements of the current embodiments, as broadly outlined and depicted in the accompanying diagrams, can be configured and organized in numerous distinct ways. Consequently, the detailed exposition of the various embodiments of the device, system, methodology, and computer program product of the current embodiments, as shown in the Figures, should not be seen as constraining the extent of the claimed embodiments. Instead, it is simply illustrative of certain embodiments.

Whenever this document mentions ‘a select embodiment,’ ‘one embodiment,’ or ‘an embodiment,’ it indicates that the specific feature, structure, or characteristic being discussed is present in at least one of the embodiments. Therefore, the use of terms like ‘a select embodiment,’ ‘in one embodiment,’ or ‘in an embodiment’ at different points in this document does not imply that they all refer to the same embodiment.

The best way to comprehend the depicted embodiments is by referring to the drawings, in which similar components are marked with identical numbers. The subsequent explanation serves merely as an illustrative example, showcasing specific chosen embodiments of devices, systems, and methods that align with the embodiments claimed in this document.

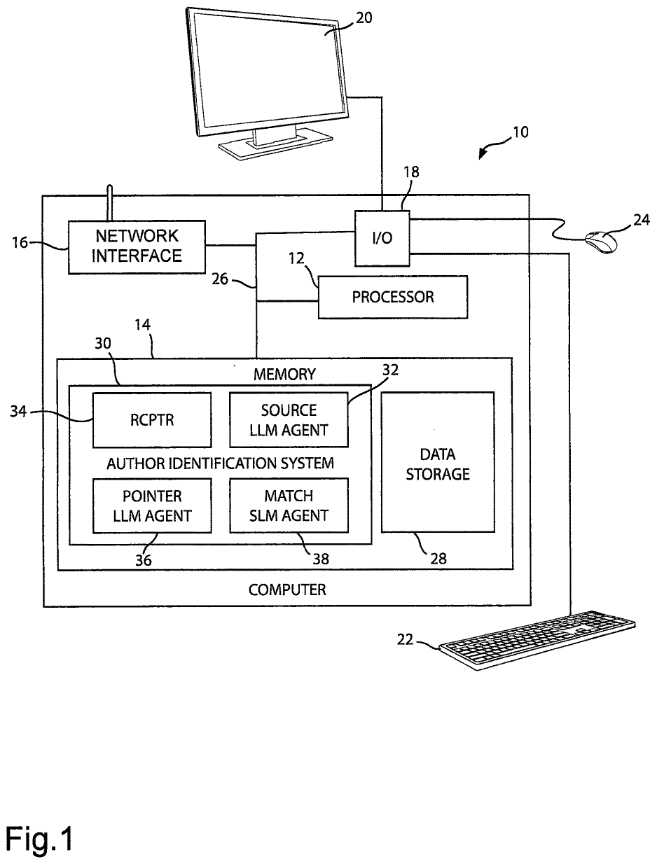

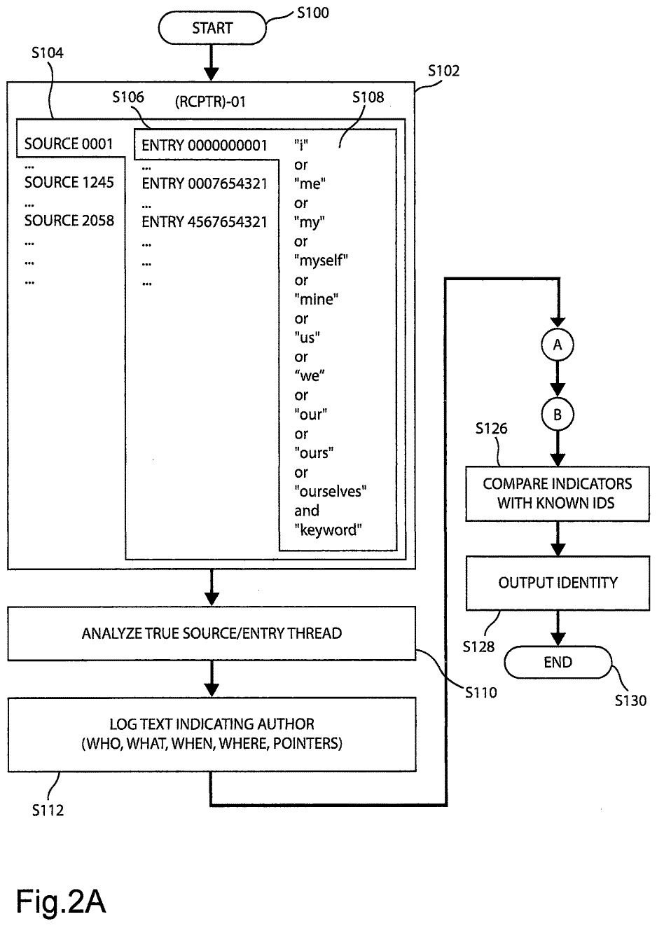

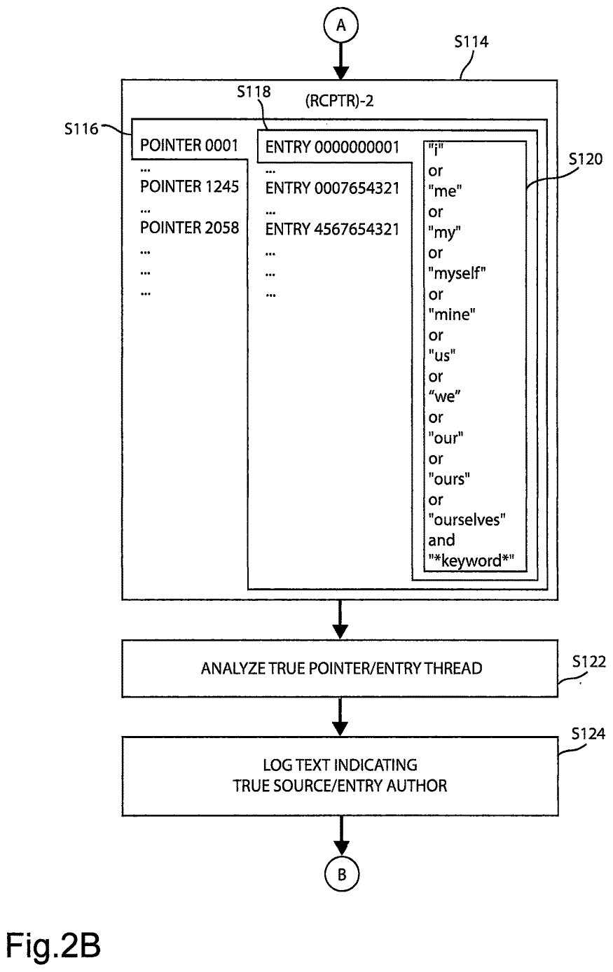

Referring to FIG. 1, a functional block diagram is presented depicting a computer system 10. The computer system is capable of reconstructing an identity from fragmented information. The depicted computer system 10 comprises a processor 12, which oversees the computer system's 10 functions by executing processing instructions stored in the connected memory 14. Additionally, the computer system 10 features a network interface 16 and a user input-output interface 18. The I/O interface 18 can interact with various devices, including a display 20 for user information, and user input tools like a keyboard 22 or a touch/writable screen for text entry, along with a cursor control device 24, such as a mouse or trackball, to relay user input and commands to the processor 12. All components of the computer 10 may be interconnected via a bus 26. The processor 12 is responsible for executing the methods detailed in FIG. 2A and/or FIG. 2B. This computer system 10 could be a personal computer, like a desktop or laptop, a handheld device like a palmtop, PDA, a mobile phone, a pager, or any other communication device with internet capabilities.

Referring to FIG. 2A, an exemplary method of utilizing an author identification system 30 is illustrated. It is to be appreciated that fewer or more steps may be included and that the steps need not proceed in the order illustrated. The method begins at step S100. At step S102, A collection of text strings, such as sentences S106, is received from one or more sources S104 by a S102 (RCPTR) recursively collected posted text receiver. Each sentence is typically in the same language, specifically the language chosen for the author identification system. This collection often consists of text strings derived directly from real messages posted by individuals. To ensure a broad representation, entries from a diverse range of sources are included. This approach increases the chances that the collection will contain a variety of common phrases and expressions typically used to characterize personalized text S108. At step S110, one or more artificially intelligent language model agents examine entries from sources that returned true for personalization. S112, log text and text fragments indicating author identity, for example, concepts of who, what, when, and where may contain fragments. Also log new sources that include elements of work, school, friends, followers, relative, associates, etc.

Referring to FIG. 2B In another embodiment, the method continues with an artificially intelligent natural language agent S122 examining the S116 pointer S118 entries logged in step S112. S114 is a (RCPTR) recursively collected posted text receiver logging received pointer entry with personalized characteristics S120. S124 fragments indicating source author identity are logged.

FIG. 2A resumes to combine logged indicators with known identities S126. S128 The source author identity is returned. The method ends at step S130.

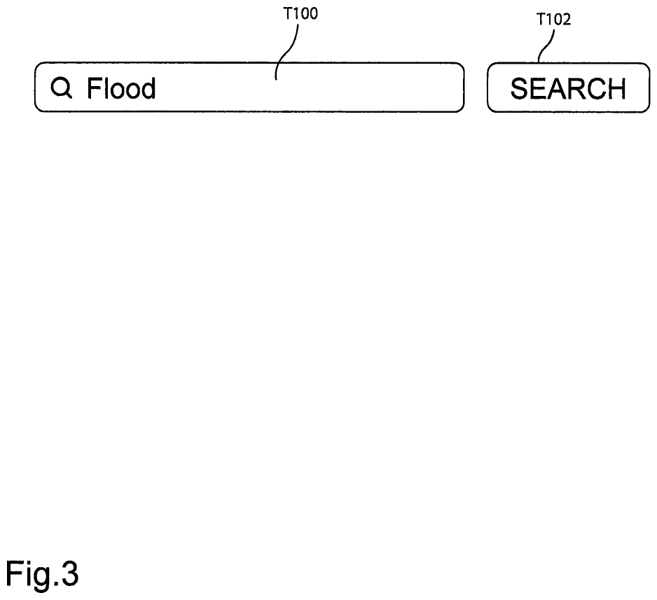

Referring to FIG. 3, another embodiment allows human interaction T102 to refine the number of entries by topic or keyword T100.

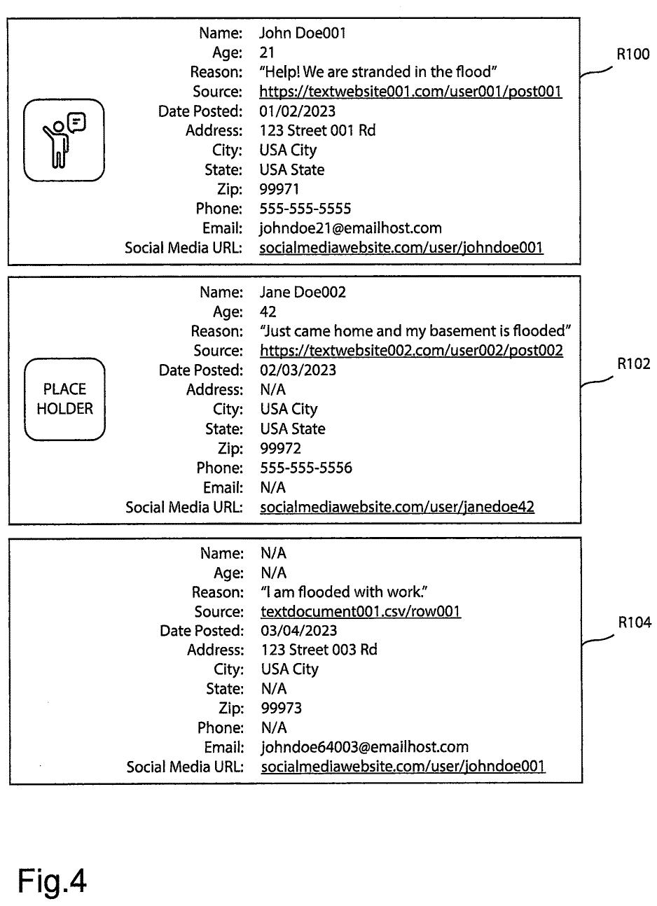

Referring to FIG. 4, exemplary results of complete author identities R100 as well as partial author identities R102 and R104 are returned and displayed.

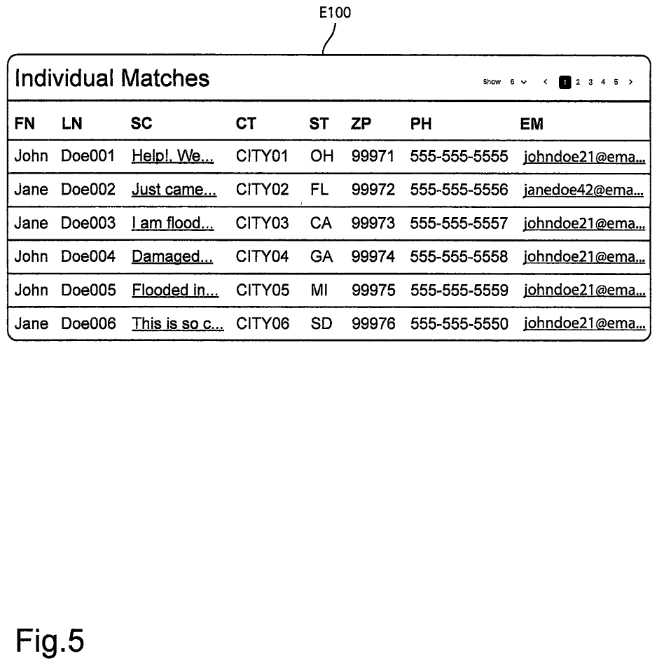

Referring to FIG. 5, in a different embodiment, exemplary results of author identities are returned and displayed in spreadsheet form E100.

1. A method of identifying an individual from text data comprising:
Utilizing artificially intelligent natural language agents within a computer program product and system instructed to match fragments of an individual's identity found in text received from a plurality of sources to known individual identities by affirming characteristics of personalization and relationships common in human identities.
